(19) United States
(12) Patent Application Publication
(10) Pub. No.: US 2004/0243797 A1
(43) Pub. Date: Dec. 2, 2004

(54) Method and apparatus for booting a computer with a memory card

(76) Inventors: Chi-Fu Yang, Hsinchu County (TW); You-Ying Yeh, Hsinchu City (TW)

Correspondence Address: BIRCH STEWART KOLASCH & BIRCH, PO BOX 747, FALLS CHURCH, VA, 22040-0747, US

(21) Appl. No.: 10/795,403

(22) Filed: Mar. 9, 2004

(30) Foreign Application Priority Data
May 26, 2003 (TW) 092114170

(51) Int. Cl. G06F 15/177

(52) U.S. Cl. 713/2

(57) ABSTRACT

A method and an apparatus for booting a computer with a memory card are disclosed. The apparatus has a portable memory card and a memory card controller chipset for booting a computer. The embedded operating system in the memory card is provided for booting the computer in a prompt, convenient and simplified manner. In addition, a user is allowed to launch applications installed in the memory card after the computer is booted.

### FIELD OF THE INVENTION

This invention relates generally to a computer and, more particularly, to a apparatus having a portable memory card and a memory card controller chipsets, where an embedded operating system in the memory card is provided for booting the computer in a prompt, convenient and simplified manner.

### BACKGROUND OF THE INVENTION

Typically, a computer by executing boot loader which loads boot codes of a designated operating system (i.e. linux OS, Windows OS) pre-installed in a hard disk, a floppy disk (for example a 1.44 floppy disk), or an optical media (CD-R). After the computer is booted and enters into operating system, user is allowed to launch various applications based on the operating system for providing functions to users. Each storage media used as booting device has advantages and disadvantages of each own kind. A hard disk is featured with high access speed and large capacity, however, it is large in volume, but heavy in weight and is not suited for use in a mobile environment. A floppy disk has advantage as being easy to carry and widely used, nonetheless, it is also noted for its limited and unreliable storage capacity. In addition, it becomes damaged easily. An optical disk is portable and has a large storage capacity, but it is restricted to read-only nature. As a result, files saved on the disc cannot be updated or replaced. Referring to FIG. 1, the R.O.C. patent publication number 517867 discloses a memory card reader for booting a computer. The memory card reader includes a circuit board 11. A socket 12 is disposed on the lateral side of the circuit board. The circuit board 11 is coupled to a micro controller 13. The socket 12 is a typical parallel port socket or a serial port socket. A floppy drive socket 14 is provided for coupling the floppy disc to a floppy drive (not shown). A micro processor 13 is a CPU in a host computer for control input/output operations between the host computer and computer peripherals coupled to the host computer. An universal serial bus is further integrated into the circuit board for establishing links between computer peripherals and the host computer. The host computer also supports booting from a peripheral device coupled via universal serial bus. Therefore, a peripheral storage device coupled to the host computer via universal serial bus is used for booting the host computer in the prior art mentioned.

Therefore, it is further desirable for a method and an apparatus for overcoming the drawbacks occurred to prior art booting device in terms of limited mobility and storage mode. The present invention comprises a memory card controller chipset installed in a host computer. The memory card chipset is provided for initiating the step of loading an embedded operating system in a compact flash card, which is seen commonly in consumer electronic products such as a digital camera. By such application, the host computer is booted in a prompt, simplified and convenient manner.

### SUMMARY OF THE INVENTION

A method and an apparatus for booting a computer with a memory card are disclosed. Such memory card is seen commonly in consumer digital products. A memory card controller is installed in the host. The embedded operating system in the memory card is provided for booting the computer in a prompt, convenient and simplified manner. In addition, a user is allowed to launch applications installed in the memory card after the computer is booted.

After the power of the host computer is switched on, the booting routines include steps as: initiating a basic input/output system, detecting a memory device controller exists or not, if so initializing the controller, inspecting whether the host computer supports memory card booting, loading embedded operating system to a system memory, and completing the host computer booting.

### BRIEF DESCRIPTION OF THE DRAWINGS

FIG. 1 is a schematic diagram illustrating a prior art memory card reader for booting a computer;

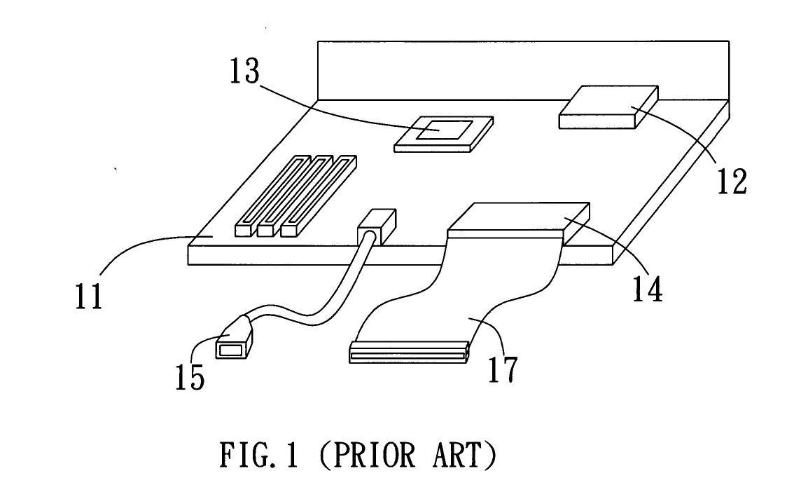

FIG. 2 is a schematic diagram illustrating a device according to a first embodiment of the method and the apparatus for booting a computer with a memory card of the present invention;

FIG. 3 is a schematic diagram illustrating a device according to a second embodiment of the method and the apparatus for booting a computer with a memory card of the present invention; and

FIG. 4 is a flow chart illustrating steps of the booting routines according to the method for booting a computer with a memory card of the present invention.

### DETAILED DESCRIPTION OF THE PREFERRED EMBODIMENTS

A memory card commonly used in consumer digital products is flash memory based storage media. A flash memory card is portable, has large storage capacity but is small in volume. In addition, a flash memory card provides a means for reliable data storage. Those advantages provided by a memory card drives explains why it becomes a popular storage device. Users utilize memory cards as mobile storage units. The method and the apparatus for booting a computer with a memory card of the present invention is implemented via a memory card controller chipset installed in a host computer for controlling a flash memory card with an embedded operating system. The embedded operating system in the memory card is used for a prompt booting of the host computer. Moreover, users are allowed to use applications in the memory card.

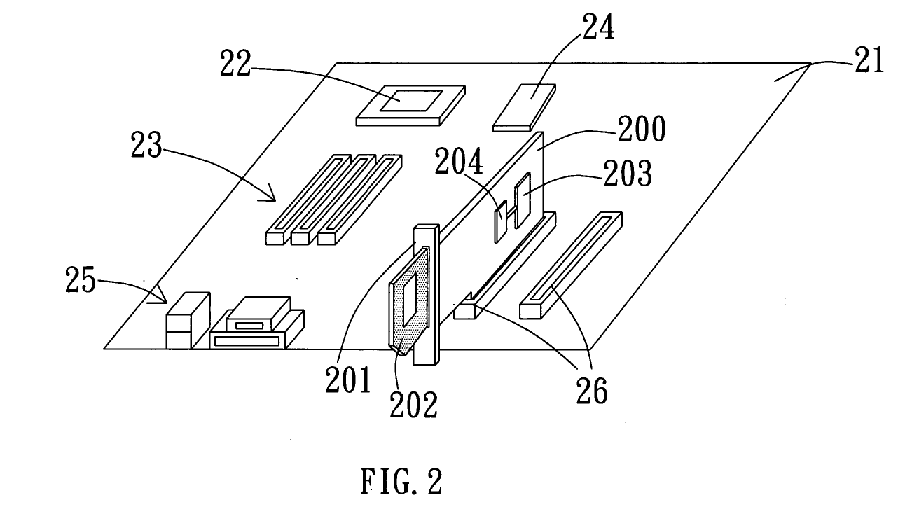

FIG. 2 illustrates a schematic diagram illustrating a device according to a first embodiment of the method and the apparatus for booting a computer with a memory card of the present invention. The apparatus in the diagram comprises a computer motherboard 21. The motherboard has a CPU 22, system memory (RAM) 23, basic input/output (BIOS) firmware 24, serial and parallel port interfaces 25, and extended bus interface sockets 26. The bus interface sockets 26 are a plurality of Peripheral Component Interconnect (PCI) bus I/O interfaces. The present invention is implemented via a memory device controller card 200 for allowing data transmits through a PCI bus I/O interface to a host computer. The memory device controller card 200 has a memory card socket 201. The memory card socket 201 is provided for coupling to a memory card 202 for accessing a flashed memory based memory card 202. A memory card controller chipset 203 having a firmware 204 for controlling the memory card controller chipset 203 is disposed on the memory device controller card 200. The firmware 204 is electrically coupled to the memory card controller chipset 203. The firmware 204 can be burned into a read-only memory (ROM) or integrated into BIOS. The firmware 204 comprises a driver of the memory card controller chipset 203 and a file system of the memory card 202, for controlling the memory card controller chipset 203 and the memory card 202. Further more the data in the memory card can be transmitted into system memory (RAM) 23 and be utilized by CPU 22.

The computer motherboard 21 has to be configured to support memory card booting, such that the memory card 202 can be used to boot the host computer. The BIOS firmware 24 has to be pre-installed with instructions for detecting the memory device controller card 200. When the host computer is powered on, The BIOS firmware 24 detects and determines whether the memory device controller card 200 exists. If the memory device controller card 200 exists, then the booting routines are transmitted from BIOS firmware 24 to firmware 204. The firmware 204 accesses the booting routines of the memory card via appropriate I/O control instructions. If the file accessed is correct, then the embedded operating system is loaded to system memory (RAM) 23 and the booting program continues to complete the host computer booting.

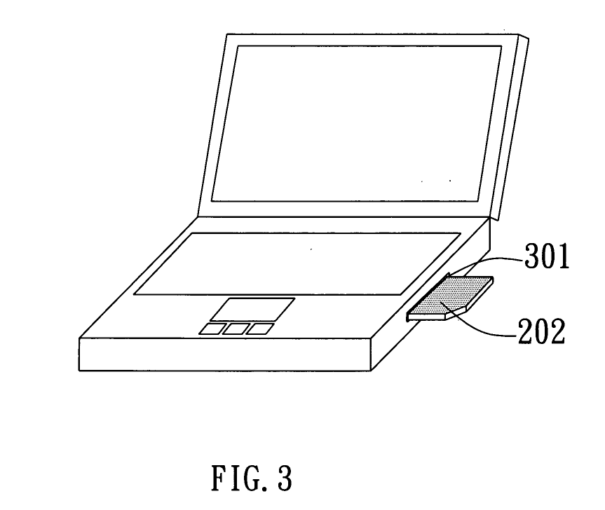

FIG. 3 is a schematic diagram illustrating a device according to a second embodiment of the method and the apparatus for booting a computer with a memory card of the present invention. An embodiment where a notebook is installed with a memory device controller card is illustrated in FIG. 3. A memory card 202 is plugged in the memory device socket 301 installed in the notebook. The booting routines of the notebook BIOS firmware includes a memory card booting detection routine. When the power of the notebook is switched on, the BIOS then detects the memory device controller card pre-installed in the notebook. The memory card 202 is plugged in the memory device controller card socket. The booting routines are transmitted from BIOS firmware to the firmware 204. The firmware 204 completes the rest of booting sequence of the notebook.

Computer system architecture includes hardware architecture, operating system, and applications. Hardware architecture applied in the present invention comprises a computer motherboard 21, a CPU 22, system memory 23, various buses and interfaces 25, a memory device controller card 200 coupled to the buses (such as PCI or PCI express buses etc.), a memory card socket 201, a memory card 202 and a memory card controller chipset 203 having firmware 204 of the memory card controller chipset as mentioned above. The operating system is an embedded operating system in the memory card 202, which is used for booting a computer and initializing some of the input/output peripherals. The applications are software pre-installed in the memory card 202 or other software installed in other media subject to user's desired configuration.

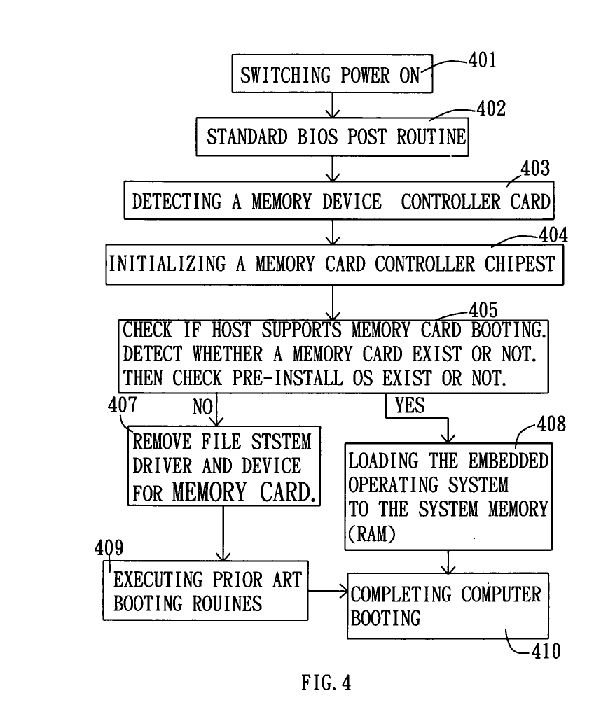

A flow chart illustrating steps of the booting routines according to the method for booting a computer with a memory card of the present invention is illustrated in FIG. 4. Such steps are described as follows. Step 401: switching on power of a host computer, Step 402: executing standard booting routines by BIOS. Step 403: detecting a memory device controller card 200 according to the present invention after the general booting routines, first detect and inspect basic component such as a CPU and a system memory (RAM) on the motherboard, then detect and determine if there is any booting storage devices such as hard drive, floppy drive and optical drive available. Step 404: initializing a memory card controller chipset, and loading the file system and the driver of the memory card from the ROM of the memory device controller to the system memory (RAM). Step 405: detects whether a memory card is plugged in the memory card socket of memory card controller, whether the memory card is pre-installed with an embedded operating system and whether the computer supports memory card booting. Step 407: if the memory card is not plugged in the memory device controller card or the computer does not support memory card booting, then remove the file system and the driver of the memory card loaded in the system memory (RAM) and continues to detect other booting storage medium. Step 409: executing booting routines according to prior art booting. Step 410: completing computer booting. Step 408: on the other hand, if the memory card having an embedded operating system is plugged in and the computer supports memory card booting, the embedded operating system is loaded to the system memory (RAM). Step 410: completing computer booting and handing the control of the hardware to the operating system initiated such that the operating system takes over control and management of the computer.

A detailed description of embodiments of a method and an apparatus for booting a computer with memory card according to the present invention is provided as above. The apparatus has a portable memory card and a memory card controller chipset for booting a computer. The operating system pre-installed in the memory card is used for replacing the operating system previously installed in the hard drive in the prior art, such that the computer is booted in a prompt, simplified and convenient manner.

While the present invention has been described in terms of a presently preferred embodiment, those skilled in the art will recognize that the invention is not limited to the embodiment described. The method and apparatus of the present invention can be practiced with modification and alteration within the spirit and scope of the appended claims. The description is thus to be regarded as illustrative instead of restrictive on the present invention.

What is claimed is:

1. A method for booting a computer with a memory card, the memory card is a flash memory card or micro drive having an embedded operating system for booting the computer in a prompt, simplified and convenient manner, the method comprises:
initiating a basic input/output system;
detecting a memory device controller card;
initializing a memory card controller chipset;
inspecting whether the host computer supports memory card booting;
loading the embedded operating system to a system memory; and
completing the host computer booting.

2. The method for booting a computer with a memory card of claim 1, wherein the step of inspecting whether the host computer supports memory card booting further comprises: if the computer does not support memory card booting, the booting routines are completed by general basic input/output firmware.

3. The method for booting a computer with a memory card of claim 1, wherein the step of inspecting whether the host computer supports memory card booting further comprises: detecting whether a memory card is coupled to the computer, and whether the embedded operating system is pre-installed in the memory card.

4. The method for booting a computer with a memory card of claim 1, wherein the step of detecting a memory device controller card further comprises: determining if the memory device controller card is a device using PCI bus or PCI express bus interface.

5. The method for booting a computer with a memory card of claim 1, wherein the memory device controller card is coupled to the memory card via a memory card socket.

6. The method for booting a computer with a memory card of claim 1, wherein a file system and a memory card driver are loaded via a firmware after the step of initializing a memory card controller chipset in the memory device controller card.

7. The method for booting a computer with a memory card of claim 6, the firmware is pre-installed in a stand alone read only memory (ROM) or combined with a basic input/output system (BIOS) chipset.

8. An apparatus for booting a computer with a memory card, the memory card is a flash memory card or micro drive having an embedded operating system for booting the computer in a prompt, simplified and convenient manner, the apparatus comprises:
a basic input/output system, pre-installed in the mother board of the computer system;
a memory device controller card, coupled to the mother board via a bus;
a memory card controller chipset; and
a firmware electrically coupled to the memory card controller chipset.

9. The apparatus for booting a computer with a memory card of claim 8, the bus is a PCI or a PCI express bus.

10. The apparatus for booting a computer with a memory card of claim 8, wherein the memory device controller is coupled to the memory card via a memory card socket.

11. The apparatus for booting a computer with a memory card of claim 8, wherein the firmware comprises a file system and a driver of the memory card controller.

12. The apparatus for booting a computer with a memory card of claim 8, the firmware is pre-installed in a stand-alone read only memory (ROM) or combined with a basic input/output system (BIOS).
